(19) United States
(12) Patent Application Publication
(10) Pub. No.: US 2004/0150654 A1
(43) Pub. Date: Aug. 5, 2004

(54) Sparkle reduction using a split gamma table

(76) Inventor: Donald Henry Willis, Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/356,110

(22) Filed: Jan. 31, 2003

(51) Int. Cl. G09G 5/02

(52) U.S. Cl. 345/602

(57) ABSTRACT

A sparkle reduction system (20) includes a first lookup table (22) and at least a second lookup table (26) and a sparkle reduction circuit (24) having an output of the first lookup table serving as an input to the sparkle reduction circuit and an output of the sparkle reduction circuit serving as an input to the second lookup table.

### BACKGROUND OF THE INVENTION

1. Technical Field

This invention relates to the field of sparkle reduction in displays and more particularly to the field of sparkle reduction in combination with gamma correction.

2. Description of Related Art

A light engine having an LCOS imager has a severe non-linearity in the display transfer function, which can be corrected by a digital lookup table, referred to as a gamma table. The gamma table corrects for the differences in gain in the transfer function. Notwithstanding this correction, the strong non-linearity of the LCOS imaging transfer function for a normally white LCOS imager means that dark areas have a very low light-versus-voltage gain. Thus, at lower brightness levels, adjacent pixels that are only moderately different in brightness need to be driven by very different voltage levels. This produces a fringing electrical field having a component orthogonal to the desired field. This orthogonal field produces a brighter than desired pixel, which in turn can produce undesired bright edges on objects. The presence of such orthogonal fields is denoted disclination. The image artifact caused by disclination and perceived by the viewer is denoted sparkle. The areas of the picture in which disclination occurs appear to have sparkles of light over the underlying image. In effect, dark pixels affected by disclination are too bright, often five times as bright as they should be. Sparkle comes in red, green and blue colors, for each color produced by the imagers. However, the green sparkle is the most evident when the problem occurs. Accordingly, the image artifact caused by disclination is also referred to as the green sparkle problem.

LCOS imaging is a new technology and green sparkle caused by disclination is a new kind of problem. Various proposed solutions by others include signal processing the entire luminance component of the picture, and in so doing, degrade the quality of the entire picture. The trade-off for reducing disclination and the resulting sparkle is a picture with virtually no horizontal sharpness at all. Picture detail and sharpness simply cannot be sacrificed in that fashion.

In the past, the disclination problem has been ameliorated by adjusting a gamma table and using a sparkle reduction circuit ahead of the gamma table. Although useful, such arrangement usually results in a non-optimal contrast ratio and colorimetry for the display. The great nonlinearity of high contrast LCOS displays in particular requires gamma correction having very high gain regions. In some cases the gain is so high that the darkest one least significant bit (LSB) transition produces too much sparkle effect.

One skilled in the art would expect the sparkle artifact problem attributed to disclination to be addressed and ultimately solved in the imager, as that is where the disclination occurs. However, in an emerging technology such as LCOS, there simply isn't an opportunity for parties other than the manufacturer of the LCOS imagers to fix the problem in the imagers. Moreover, there is no indication that an imager-based solution would be applicable to all LCOS imagers. Accordingly, there is an urgent need to provide a solution to this problem that can be implemented without modifying the LCOS imagers using gamma correction yet overcoming the detriments described above.

### SUMMARY

In a first aspect of the invention, a sparkle reduction system comprises a first lookup table and at least a second lookup table. The system further comprises a sparkle reduction circuit having the output of the first lookup table serving as an input to the sparkle reduction circuit and an output of the sparkle reduction circuit serving as an input to the second lookup table.

In a second aspect of the invention, a method of reducing sparkle in a display using a split gamma table and a sparkle reduction circuit between gamma tables of the split gamma table comprises the step of generating a desired gamma function when an output of at least a first gamma table of the split gamma table is sent unaltered by the sparkle reduction circuit to at least a second gamma table of the split gamma table and the step of generating values between the desired gamma function when the sparkle reduction circuit operates on a transient.

In a third aspect of the present invention, a method of reducing sparkle in a display using a split gamma table and a sparkle reduction circuit between gamma tables comprises the step of generating a desired gamma function as an output when no transient signal is detected and generating values between the desired gamma function as an output when a transient is detected. The transient can be detected by a sparkle reduction circuit.

### BRIEF DESCRIPTION OF THE DRAWINGS

FIG. 1 is a block diagram of an existing sparkle reduction system having a sparkle reduction circuit ahead of a gamma table.

FIG. 2 is a block diagram of a sparkle reduction system in accordance with the present invention.

FIG. 3 is a diagram useful for explaining the split gamma table arrangement of the sparkle reduction system in accordance with the present invention.

FIG. 4 is a flow chart illustrating a method in accordance with the present invention.

### DETAILED DESCRIPTION OF THE PREFERRED EMBODIMENTS

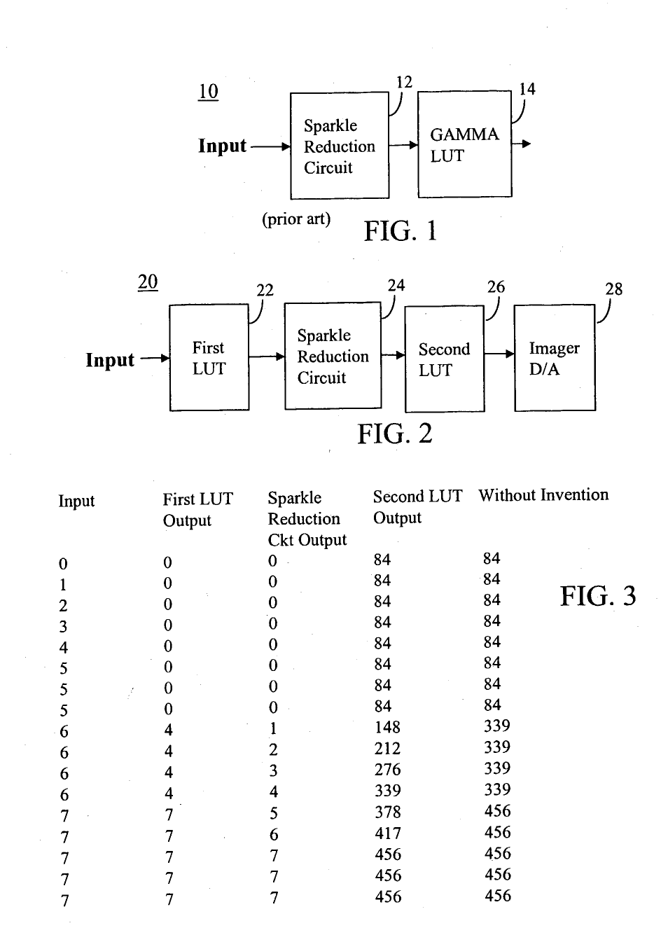

As discussed above, the disclination problem has been ameliorated by adjusting a gamma table 12 and using a sparkle reduction circuit 14 ahead of the gamma table 12 as shown in the circuit 10 FIG. 1. The great nonlinearity of high contrast LCOS displays in particular requires gamma correction having very high gain regions in order to optimize contrast ratio and colorimetry for the display. The gain in some instances is so high that the darkest one least significant bit (LSB) transition produces too much sparkle effect even with a strong sparkle reduction circuit present.

Referring to FIG. 2, a sparkle reduction system 20 using a split gamma table or a composite gamma table in accordance with the present invention is shown. The split gamma table or composite gamma table preferably comprises a first lookup table or first gamma table 22 and at least a second lookup table or second gamma table 26. The split gamma table (22 and 26) operates in tandem with a sparkle reduction circuit 24. The sparkle reduction circuit 24 can be a slew rate limiter circuit for example. The sparkle reduction circuit 24 has the output of the first lookup table 22 serving as an input to the sparkle reduction circuit 24 and an output of the sparkle reduction circuit 24 serving as an input to the second lookup table 26. The output of the second lookup table 26 can be provided to an imager digital-to-analog converter 28. The composite response of the split gamma table is optimized for contrast and colorimetry. The split allows effective sparkle reduction even with a composite response that has too great a transition for one LSB change in greyshade. It should be understood that although the split gamma table of system 20 illustrates only two tables, the present invention is not limited thereto.

The first and second lookup tables (22 and 26) taken together form the composite gamma table which provides a desired gamma function as reflected in the column labeled “Without Invention” in FIG. 3. Operationally, as illustrated by FIG. 3, if an input value enters the first gamma table 22 and the output from the first gamma table is sent unaltered to the second gamma table 26 (of FIG. 2), then the result is equal to the desired gamma function. If the sparkle reduction circuit 24 does not alter the signal (no transients), then the result is the same as though a single gamma table of the desired gamma function were used with no sparkle reduction circuit. The desired gamma function in FIG. 3 is shown for illustrative purposes only with the understanding that the present invention can certainly use this desired gamma function or other desired gamma functions within contemplation of the present invention.

The sparkle reduction circuit only operates on transients that occur in the darker regions of the image. Thus, only the sparkle reduction circuit 24 can ever produce the outputs from the second gamma table 26 having the values of 148, 212, 276, 378, and 417 using sparkle reduction circuit outputs of 1, 2, 3, 5 and 6 respectively. In other words, the sparkle reduction circuit generates outputs that uniquely provide inputs 1, 2, 3, 5 and 6 to the second gamma table. These values are “in between” the values of the desired gamma function and are available to be used as outputs from the sparkle reduction circuit 24 when it needs to reduce the sparkle on a transient. Any large objects without dark transients will otherwise be reproduced according to the desired gamma function and should have desired contrast and colorimetry properties. It should be noted that the gamma tables in FIG. 3 only show a positive portion of the table. The negative portion of the table would need to be included in a similar manner. It should also be noted that since the first gamma table is relatively small in terms of address range and output, the first gamma table 22 could easily be embedded or integrated into the sparkle reduction circuit 24 in a memory such as a small read only memory (ROM).

Taking the example where a transient comes in and the input was previously 5 and now it is 6, without the present invention, the value would jump from 84 to 339 for a one LSB transition and create a large sparkle effect. This 255 point change in value approximates a 25% change in the dynamic range for a 10 bit signal that has the decimal equivalent range of 0 to 1023 for example. Using the present invention, the sparkle reduction circuit 24 can soften the transitions with much reduced step sizes. In the embodiment shown in FIG. 3, the first LSB transition has been split into 4 steps (84, 148, 212, and 276) instead of 1 step and the next LSB transition has been split into 3 steps (339, 378, and 417) instead of 1 step.

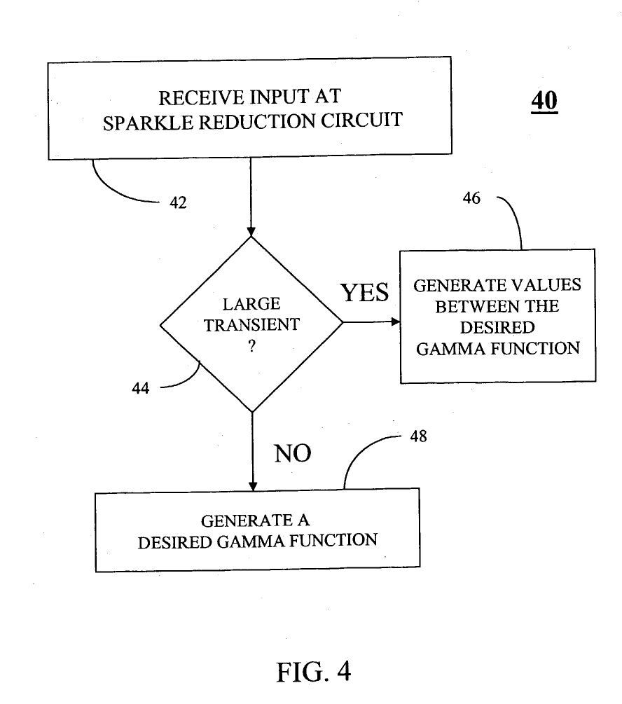

Referring to FIG. 4, a flowchart is shown illustrating a method 40 of reducing sparkle in a display using a split gamma table in tandem with a sparkle reduction circuit. The split gamma table can include a first gamma table and a second gamma table. The method 40 can begin at step 42 by receiving inputs at a sparkle reduction circuit. At decision block 44, it can be determined if there is a large transient signal. If no large transient is found, the method at step 48 generates a desired gamma function when an output of the first gamma table is sent unaltered by the sparkle reduction circuit to the second lookup table. If the sparkle reduction circuit operates on a large transient, then the method generates values between the desired gamma function at step 46, preferably when the sparkle reduction circuit operates on transients that occur in a darker region of the image. The first gamma table and the second gamma table preferably form a composite gamma table having a composite response optimized for contrast and colorimetry and effectively reduces sparkle where the composite response has a large transition in its output for a least significant bit transition in its input.

In light of the foregoing description of the invention, it should be recognized that the present invention can be realized in hardware, software, or a combination of hardware and software. A method of reducing sparkle according to the present invention can be realized in a centralized fashion in one processing system, or in a distributed fashion where different elements are spread across several interconnected systems. Any kind of computer system, or other apparatus adapted for carrying out the methods described herein, is suited. A typical combination of hardware and software could be a general purpose computer processor or digital signal processor with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

What is claimed is:

1. A sparkle reduction system, comprising:
a first lookup table and at least a second lookup table; and
a sparkle reduction circuit having an output of the first lookup table serving as an input to the sparkle reduction circuit and an output of the sparkle reduction circuit serving as an input to the second lookup table.

2. The sparkle reduction system of claim 1, wherein the first and at least the second lookup tables form a composite gamma table.

3. The sparkle reduction system of claim 2, wherein the composite lookup table provides a desired gamma function when the output of the first lookup table is sent unaltered by the sparkle reduction circuit to at least the second lookup table.

4. The sparkle reduction system of claim 1, wherein the sparkle reduction circuit only operates on transient signals.

5. The sparkle reduction system of claim 1, wherein the first lookup table and at least the second lookup table each have positive and negative portions.

6. The sparkle reduction system of claim 3, wherein the second lookup table generates values between the values of the desired gamma function when the sparkle reduction circuit operates on transients in a darker region of an image.

7. The sparkle reduction system of claim 1, wherein the sparkle reduction system is used in conjunction with a liquid crystal on silicon display.

8. The sparkle reduction system of claim 1, wherein the first lookup table and the sparkle reduction circuit are integrated.

9. A method of reducing sparkle in a display using a first gamma table and a second gamma table in tandem with a sparkle reduction circuit, comprising the steps of:
generating a desired gamma function when an output of the first gamma table is sent unaltered by the sparkle reduction circuit to the second lookup table; and
generating values between the desired gamma function when the sparkle reduction circuit operates on a transient.

10. The method of reducing sparkle of claim 9, wherein the step of generating values between the desired gamma function occurs when the sparkle reduction circuit operates on transients that occur in a darker region of the image.

11. The method of reducing sparkle of claim 9, wherein the first gamma table and the second gamma table form a composite gamma table having a composite response optimized for contrast and colorimetry.

12. The method of reducing sparkle of claim 11, wherein the composite gamma table enables effective sparkle reduction where the composite response has a large transition in its output for a least significant bit transition in its input.

13. A method of reducing sparkle in a display using a split gamma table and a sparkle reduction circuit between gamma tables of the split gamma table, comprising the steps of:
generating a desired gamma function when an output of at least a first gamma table of the split gamma table is sent unaltered by the sparkle reduction circuit to at least a second gamma table of the split gamma table; and
generating values between the desired gamma function when the sparkle reduction circuit operates on a transient.

14. The method of reducing sparkle of claim 13, wherein the step of generating values between the desired gamma function occurs when the sparkle reduction circuit operates on transients that occur in a darker region of the image.

15. The method of reducing sparkle of claim 13, wherein the first gamma table and the second gamma table form the split gamma table having a composite response optimized for contrast and colorimetry.

16. The method of reducing sparkle of claim 15, wherein the split gamma table enables effective sparkle reduction where the composite response has a large transition in its output for a least significant bit transition in its input.

17. A method of reducing sparkle in a display using a split gamma table and a sparkle reduction circuit between gamma tables of the split gamma table, comprising the steps of:
generating a desired gamma function as an output when no transient signal is detected; and
generating values between the desired gamma function as an output when a transient is detected.

18. The method of claim 17, wherein the method further comprises the step of providing the output to an imager digital to analog converter.
